(19) United States
(12) Patent Application Publication
(10) Pub. No.: US 2025/0319452 A1
(43) Pub. Date: Oct. 16, 2025

(54) DESICCANT BASED HUMIDITY REGULATOR

(71) Applicant: Manish Jain, Pune (IN)

(72) Inventors: Manish Jain, Pune (IN); Vivek Kumar JHA, Pune (IN)

(21) Appl. No.: 18/873,600

(22) PCT Filed: Jun. 10, 2023
(86) PCT No.: PCT/IN2023/050548

§ 371 Date: Dec. 10, 2024

(30) Foreign Application Priority Data
Jun. 11, 2022 (IN) 202221033555

(51) Int. Cl. B01J 20/10; B01D 53/02; B01D 53/26; B01D 53/28; B01J 20/04; B01J 20/18; B01J 20/22; B01J 20/28

(52) U.S. Cl. CPC B01J 20/103; B01D 53/02; B01D 53/261; B01D 53/28; B01J 20/045; B01J 20/18; B01J 20/223; B01J 20/28004; B01J 20/28047; B01D 2253/106; B01D 2253/116; B01D 2253/20; B01D 2257/104; B01D 2257/80; B01D 2258/06

(57) ABSTRACT

The present invention discloses desiccant based humidity regulators for maintaining and controlling prolonged constant relative humidity in specific container. The humidity regulator composition includes a desiccant, an additive and a humectant. The composition includes 25 to 85% silica gel, 10 to 38% alum and 10 to 25% humectant. The humectant is a glycerin and water solution maintained in ratio 70:30. The composition also optionally includes oxygen absorber composition for absorption of oxygen. The composition is packaged in a laminated pouch. The composition increases the shelf life of products like foods, pharmaceuticals, artifacts, musical instruments, wood articles, botanicals, herbs, nutraceuticals etc. that are sensitive to both moisture and oxygen.

### FIELD OF THE INVENTION

The present invention relates to a humidity regulator and more particularly to a desiccant-based humidity regulators for maintaining and controlling prolonged constant relative humidity in specific container. The present invention also relates to a desiccant based humidity regulators along with oxygen absorption property.

### BACKGROUND OF THE INVENTION

High levels of humidity in the atmosphere can cause some products to absorb the moisture from the atmosphere. If products absorb moisture from the atmosphere, there is a high possibility of degradation of those products. Similarly, oxygen can be detrimental to the shelf life of food, nutraceuticals and pharmaceuticals. As a result, the potency and nutritional value of that product is lost. Therefore, the pharmaceutical and nutraceutical products require protection from moisture, oxidation and contaminants to preserve their shelf life.

Desiccants are routinely employed for absorbing moisture from the atmosphere to protect the products. However, there are products that are sensitive to moisture content. Using desiccants in case of such products leads to complete removal of moisture which is not desirable. Humidity regulators on the other hand regulate the moisture available to the product. Humidity regulators maintain the relative humidity (RH) required for the product to be in its ideal from.

EP0363194A2 to Spruill David B et al. suggests the blend of glucose and tripotassium citrate monohydrate to keep cigarettes usable for longer time period. U.S. Pat. No. 5,936,178A to Saari Albert L discloses different saturated salt solutions and thickening agents in pouches with controlled moisture vapor transmission rate (MVTR) at different relative humidity conditions. U.S. Pat. No. 6,244,432B1 to Saari Albert L and Esse Robert L. teaches the use of saturated salt solutions in gun cases. U.S. Pat. No. 8,748,723B1 to Egberg David C. and Esse Robert L discloses the further use of humidity regulating applications for keeping wood products free from deterioration due to moisture.

The available humidity regulators cited in the prior art disclose salts/sugars and humectants for regulating humidity. These humidity regulators have limitations like buffering effect due to salt dissolution, development of black spots on outer layers of pouch due to oxidation, etc. Also, the use of gelling agents like xanthan gum or vegetable gum creates the possibility of lump formation while using salt or sugar as humidity absorbers.

There is a need for an improved humidity regulator composition that solves the problems of prior art and shows good humidity regulating capability.

### SUMMARY OF THE INVENTION

The present invention describes a desiccant based humidity regulator composition. The composition includes a desiccant in a range of 25 to 85%, an additive in a range of 10 to 38%, and a humectant in a range of 10 to 25%. The desiccant is silica gel having particle size between 200 to 400 mesh. The desiccant has water activity (Aw) in the range of 0.65 to 0.68.

The additive in the desiccant based humidity regulator composition is powdered alum. The humectant is a solution of glycerin and water having water activity between 0.58 to 0.60. The ratio of glycerin and water in humectant is 70:30.

The desiccant-based humidity regulator of the present invention optionally includes an oxygen absorber composition. The composition includes a desiccant in a range of 20 to 60%, an additive in a range of 5 to 25%, a humectant in a range of 5 to 20%, and an oxygen absorber composition in a range of 5 to 20%. The oxygen absorber composition includes a sodium L-ascorbate in a range of 38 to 42%, a sodium sulphite in a range of 18 to 25%, and a molecular sieve 4A in a range of 19 to 22%.

The desiccant-based humidity regulator composition along with oxygen absorber composition includes the desiccant silica gel having particle size between 200 to 400 mesh and water activity (Aw) in the range of 0.65 to 0.68, additive as powdered alum and a solution of glycerin and water in ratio 70:30 as humectant having water activity between 0.58 to 0.60.

### BRIEF DESCRIPTION OF DRAWINGS

The objectives and advantages of the present invention will become apparent from the following description read in accordance with the accompanying drawings wherein,

FIG. 1 demonstrates the tolerance window to regulate relative humidity with the desiccant-based humidity regulator in accordance with the present invention.

### DESCRIPTION OF THE INVENTION

The present invention relates to desiccant based humidity regulators for maintaining and controlling prolonged constant relative humidity in specific container. The present invention also relates to desiccant based humidity regulators along with oxygen absorption properties.

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The foregoing description of specific embodiments of the present invention has been presented for purposes of illustration and description. They are not intended to be exhaustive or to limit the present invention to the precise forms disclosed and obviously many modifications and variations are possible in light of the above teaching.

In one aspect, the present invention provides humidity regulator for maintaining and controlling prolonged constant relative humidity in specific container.

In another aspect, the present invention provides humidity regulators along with oxygen absorption properties.

In accordance with a preferred embodiment of the present invention, the humidity regulator composition includes the following components:
1. a desiccant in a range of 25 to 85%,
2. an additive in a range of 10 to 38%, and
3. a humectant in a range of 10 to 25%.

In accordance with this embodiment, the desiccant is silica gel having particle size between 200 to 400 mesh and water activity (Aw) in the range of 0.65 to 0.68. The additive is powdered alum (KAI (SO₄)₂·12 H₂O). The humectant is a solution of glycerin and water in 70:30 ratio and having water activity between 0.58 to 0.60.

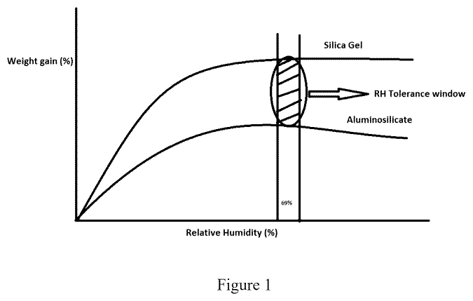

The relative humidity (RH) is maintained with the help of desiccants and the required RH is maintained by using an active desiccant silica gel with an additive alum, that follows the adsorption isotherm path for RH controlling humectant. The desired RH (62%, 69% or 55%) is obtained by including the desiccant, additive and humectant solution in specific ratios (1:1:2, 3:3:2 or 1:1:3 respectively); as provided in examples 1, 2 or 3. The RH obtained through this composition is maintained with the use of humectant that provides a tolerance window to regulate RH within the packaging atmosphere as shown in FIG. 1.

The moisture adsorbed silica gel having the water activity (Aw) equivalent to the desired RH is added with alum to form aluminosilicate that is capable of adsorbing moisture on increasing RH conditions. The presence of humectant creates a restriction window to keep the RH constant for longer duration. Consequently, the moisture adsorbed silica gel doesn't allow the RH to decrease; aluminosilicate doesn't allow the RH to increase and humectant keeps the RH unchanged within the target tolerance window.

In accordance with the present invention, silica gel is the major component responsible for absorption of moisture to reach a water activity of desired Aw. Aluminosilicate is formed through the chemical interaction of aluminium from alum and silica from silica gel when mixed in a specific ratio. The required RH tolerance window is obtained by using glycerin and water in 70:30 ratio in the present composition.

As the relative humidity increases beyond the required value, the desiccant starts taking excess moisture and similarly humectant starts releasing the moisture when the RH decreases with/without any variation in temperature.

The alum maintains relative humidity for longer duration in the composition. Also, the moisture adsorbed on aluminosilicates content present in alum has better activity at medium RH of 40% to 70%. Further, there are evidences in literature on the use of alum as disinfectant that inhibits the mold formation in products under preservation.

In an alternative embodiment, the humidity regulator composition optionally includes an oxygen absorber composition. In accordance with this embodiment, the composition includes:
1. a desiccant in a range of 20 to 60%,
2. an additive in a range of 5 to 25%,
3. a humectant in a range of 5 to 20%, and
4. an oxygen absorber composition in the range of 5 to 20%.

In accordance with this embodiment, the desiccant is silica gel having particle size between 200 to 400 mesh and water activity (Aw) in the range of 0.65 to 0.68. The additive is powdered alum. The humectant is a solution of glycerin and water in 70:30 ratio and having water activity between 0.58 to 0.60.

The oxygen absorber composition includes:
i. 38 to 42% of sodium L-ascorbate;
ii. 18 to 25% of sodium sulphite and
iii. 19 to 22% of molecular sieve 4A.

The addition of sodium L-ascorbate along with sodium sulphite and molecular sieve 4A restricts the formation of black spots on the package, a limitation of using sodium L-ascorbate conventionally. The addition of molecular sieve 4A facilitates the moisture absorption at low RH conditions, resulting slow but consistent oxidative properties of sodium L-ascorbate.

The humidity regulator composition of the present invention is packaged in a laminated pouch. These laminates have appreciable MVTR values ranging 2500 to 4000 g/m²-day for RH maintenance. The moderate MVTR value of laminated pouch allows the composition to keep it active throughout the application.

These and other embodiments will be apparent to those of skill in the art and others in view of the following detailed description of some embodiments. It should be understood, however, that this summary, and the detailed description illustrate only some examples of various embodiments and are not intended to be limiting to the invention as claimed.

### Examples

Only a few examples and implementations are disclosed. Variations, modifications, and enhancements to the described examples and implementations and other implementations can be made based on what is disclosed.

Examples are set forth herein below and are illustrative of different amounts and types of reactants and reaction conditions that can be utilized in practicing the disclosure. It will be apparent, however, that the disclosure can be practiced with other amounts and types of reactants and reaction conditions than those used in the examples, and the resulting devices various different properties and uses in accordance with the disclosure above and as pointed out hereinafter.

In the experiments, several compositions were obtained by varying the addition ratio of silica gel with alum. A variation in the optimized RH % of 62%, 69% and 55% is summarized in below examples. Though, other RH % between 20% to 75% can be prepared by careful variation of suggested compositions.

### Example 1: Preparation of Humidity Regulator Mixture for 62% RH

1 ml of powdered silica gel of particle size between 200 to 400 mesh having water activity (Aw) 0.65 to 0.68 was mixed with 1 ml of powdered alum and 2 ml of liquid humectant solution. It was filled in a laminated pouch and kept along with a digital hygrometer in LDPE sheet packet having dimensions 10×12×2 inch³.

Result: The humidity inside the pouch remained constant for more than 100 days of observation with a deviation of +2° C. as shown in below Table 1.

TABLE 1
62% RH maintained for more than 100 days

| Sr. No. | Week Number | RH % |
|---|---|---|
| 1 | 1 | 62 |
| 2 | 2 | 62 |
| 3 | 3 | 61 |
| 4 | 4 | 62 |
| 5 | 5 | 62 |
| 6 | 6 | 63 |
| 7 | 7 | 62 |
| 8 | 8 | 63 |
| 9 | 9 | 62 |
| 10 | 10 | 61 |
| 11 | 11 | 62 |
| 12 | 12 | 62 |
| 13 | 13 | 62 |
| 14 | 14 | 62 |
| 15 | 15 | 62 |
| 16 | 16 | 62 |

### Example 2: Preparation of Humidity Regulator Mixture for 69% RH

3 ml of powdered silica gel of particle size between 200 to 400 mesh a having water activity (Aw) 0.65 to 0.68 was mixed with 3 ml of powdered alum and 2 ml of liquid humectant solution. It was filled in a laminated pouch and kept along with a digital hygrometer in LDPE sheet packet having dimensions 10×12×2 inch³.

Result: The humidity inside the pouch remained constant for more than 100 days of observation with a deviation of +2° C. as shown in below Table 2

TABLE 2
69% RH maintained for more than 100 days

| Sr. No. | Week Number | RH % |
|---|---|---|
| 1 | 1 | 69 |
| 2 | 2 | 71 |
| 3 | 3 | 68 |
| 4 | 4 | 69 |
| 5 | 5 | 69 |
| 6 | 6 | 69 |
| 7 | 7 | 69 |
| 8 | 8 | 69 |
| 9 | 9 | 69 |
| 10 | 10 | 69 |
| 11 | 11 | 69 |
| 12 | 12 | 69 |
| 13 | 13 | 69 |
| 14 | 14 | 69 |
| 15 | 15 | 68 |
| 16 | 16 | 69 |

### Example 3: Preparation of Humidity Regulator Mixture for 55% RH

1 ml of powdered silica gel of particle size between 200 to 400 mesh having water activity (Aw) 0.65 to 0.68 was mixed with 1 ml of powdered alum and 3 ml of liquid humectant solution. It was filled in a laminated pouch and kept along with a digital hygrometer in LDPE sheet packet having dimensions 10×12×2 inch³.

Result: The humidity inside the pouch remained constant for more than 100 days of observation with a deviation of +2° C. as shown in below Table 3.

TABLE 3
55% RH maintained for more than 100 days

| Sr. No. | Week Number | RH % |
|---|---|---|
| 1 | 1 | 55 |
| 2 | 2 | 54 |
| 3 | 3 | 55 |
| 4 | 4 | 53 |
| 5 | 5 | 55 |
| 6 | 6 | 54 |
| 7 | 7 | 55 |
| 8 | 8 | 55 |
| 9 | 9 | 56 |
| 10 | 10 | 55 |
| 11 | 11 | 55 |
| 12 | 12 | 55 |
| 13 | 13 | 54 |
| 14 | 14 | 54 |
| 15 | 15 | 55 |
| 16 | 16 | 55 |

### Example 4: Preparation of Humidity Regulator Mixture for 62% RH Along with Oxygen Absorber Composition

200 g of Silica gel was absorbed at 25° C. and RH of 80% was maintained for 2 days in a desiccator. Similarly, about 200 g of Molecular Sieve 4A was also absorbed at 25° C. and RH of 80% was maintained for 2 days in a desiccator. A mixture containing 38 to 42% of Sodium L-ascorbate, about 18 to 25% of Sodium sulphite, about 11 to 18% of water, about 18 to 24% of moisture absorbed silica gel and about 19 to 22% of moisture absorbed molecular sieve 4A was mixed homogenously with equal volume of liquid humectant solution as defined above instantly and filled in a laminated pouch and kept along with a digital hygrometer in LDPE sheet packet having dimensions 10×12×2 inch³. Two similar pouches were prepared separately and kept inside an LDPE sealed bottle of air volume capacity of 100 cc and 250 cc respectively for oxygen absorption performance measurement.

Result: The humidity inside the pouch remained constant at 62% for more than 100 days of observation with a deviation of ±2° C. as shown in below Table 4. 5.2 ml and 5.5 ml of oxygen absorbed after 9 days in 100 ml and 250 ml air volume bottles respectively.

TABLE 4
62% RH maintained for more than 100
days and oxygen absorbed in ml

| | Week | | Volume of | Oxygen |
|---|---|---|---|---|
| Sr. No. | Number | RH % | bottle (ml) | uptake (ml) |
| 1 | 1 | 62 | 100 | 4.6 |
| 2 | 2 | 63 | 100 | 5.4 |
| 3 | 3 | 63 | 100 | 5.5 |
| 4 | 4 | 64 | 100 | 5.4 |
| 5 | 5 | 62 | 100 | 5.6 |
| 6 | 6 | 61 | 100 | 5.8 |
| 7 | 7 | 61 | 100 | 9.1 |
| 8 | 8 | 62 | 100 | 9.1 |
| 9 | 9 | 62 | 100 | 9.7 |
| 10 | 10 | 62 | 100 | 6.8 |
| 11 | 11 | 64 | 100 | 8.6 |
| 12 | 12 | 62 | 100 | 5.9 |
| 13 | 13 | 61 | 100 | 5.8 |
| 14 | 14 | 62 | 100 | 6.4 |
| 15 | 15 | 62 | 100 | 5.8 |
| 16 | 16 | 62 | 100 | 6.6 |

### Example 5: Preparation of Humidity Regulator Mixture for 69% RH Along with Oxygen Absorber Composition

200 g of Silica gel was absorbed at 25° C. and RH of 80% was maintained for 2 days in a desiccator. Similarly, about 200 g of Molecular Sieve 4A was also absorbed at 25° C. and RH of 80% was maintained for 2 days in a desiccator. A mixture containing 38 to 42% of Sodium L-ascorbate, about 18 to 25% of Sodium sulphite, about 11 to 18% of water, about 18 to 24% of 20 moisture absorbed silica gel and about 19 to 22% of moisture absorbed molecular sieve 4A was mixed homogenously with equal volume of liquid humectant solution as defined above instantly and filled in a laminated pouch and kept along with a digital hygrometer in LDPE sheet packet having dimensions 10×12×2 inch³. Two similar pouches were prepared separately and kept inside an LDPE sealed bottle of air volume capacity of 100 cc and 250 cc respectively for oxygen absorption performance measurement.

Result: The humidity inside the pouch remained constant at 69% for more than 100 days of observation with a deviation of +2° C. as shown in below Table 5. 5.6 ml and 6.2 ml of oxygen absorbed after 9 days in 100 ml and 250 ml air volume bottles respectively.

TABLE 5
69% RH maintained for more than 100
days and oxygen absorbed in ml

| | Week | | Volume of | Oxygen |
|---|---|---|---|---|
| Sr. No. | Number | RH % | bottle (ml) | uptake (ml) |
| 1 | 1 | 69 | 100 | 4.6 |
| 2 | 2 | 69 | 100 | 5.4 |
| 3 | 3 | 68 | 100 | 5.5 |
| 4 | 4 | 69 | 100 | 5.4 |
| 5 | 5 | 69 | 100 | 5.6 |
| 6 | 6 | 69 | 100 | 5.8 |
| 7 | 7 | 68 | 100 | 9.1 |
| 8 | 8 | 68 | 100 | 9.1 |
| 9 | 9 | 69 | 100 | 9.7 |
| 10 | 10 | 69 | 100 | 6.8 |
| 11 | 11 | 69 | 100 | 8.6 |
| 12 | 12 | 68 | 100 | 5.9 |
| 13 | 13 | 67 | 100 | 5.8 |
| 14 | 14 | 68 | 100 | 6.4 |
| 15 | 15 | 68 | 100 | 5.8 |
| 16 | 16 | 69 | 100 | 6.6 |

### Example 6: Preparation of Humidity Regulator Mixture for 55% RH Along with Oxygen Absorber Composition

200 g of Silica gel was absorbed at 25° C. and RH of 80% was maintained for 2 days in a desiccator. Similarly, about 200 g of Molecular Sieve 4A was also absorbed at 25° C. and RH of 80% was maintained for 2 days in a desiccator. A mixture containing 38 to 42% of Sodium L-ascorbate, about 18 to 25% of Sodium sulphite, about 11 to 18% of water, about 18 to 24% of moisture absorbed silica gel and about 19 to 22% of moisture absorbed molecular sieve 4A was mixed homogenously with equal volume of liquid humectant solution as defined above instantly and filled in a laminated pouch and kept along with a digital hygrometer in LDPE sheet packet having dimensions 10×12×2 inch³. Two similar pouches were prepared separately and kept inside an LDPE sealed bottle of air volume capacity of 100 cc and 250 cc respectively for oxygen absorption performance measurement.

Result: The humidity inside the pouch remained constant at 55% for more than 100 days of observation with a deviation of +2° C. as shown in below Table 6. 6.2 ml and 8.5 ml of oxygen absorbed after 9 days in 100 ml and 250 ml air volume bottles respectively.

TABLE 6
55% RH maintained for more than 100
days and oxygen absorbed in ml

| | Week | | Volume of | Oxygen |
|---|---|---|---|---|
| Sr. No. | Number | RH % | bottle (ml) | uptake (ml) |
| 1 | 1 | 55 | 100 | 4.6 |
| 2 | 2 | 54 | 100 | 6.3 |
| 3 | 3 | 56 | 100 | 6.4 |
| 4 | 4 | 55 | 100 | 6.3 |
| 5 | 5 | 54 | 100 | 6.2 |
| 6 | 6 | 54 | 100 | 5.8 |
| 7 | 7 | 54 | 100 | 8.0 |
| 8 | 8 | 54 | 100 | 7.1 |
| 9 | 9 | 55 | 100 | 4.1 |
| 10 | 10 | 55 | 100 | 6.6 |
| 11 | 11 | 55 | 100 | 8.5 |
| 12 | 12 | 55 | 100 | 5.8 |
| 13 | 13 | 54 | 100 | 6.8 |
| 14 | 14 | 55 | 100 | 7.4 |
| 15 | 15 | 55 | 100 | 4.8 |
| 16 | 16 | 55 | 100 | 6.8 |

The composition of desiccant based humidity regulator advantageously maintains and controls prolonged constant relative humidity in specific container. The desiccant-based humidity regulator increases the shelf life of products like foods, pharmaceuticals, artifacts, musical instruments, wood articles, botanicals, herbs, nutraceuticals etc. that are sensitive to both moisture and oxygen.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

1. A desiccant based humidity regulator composition, comprising:
a desiccant in a range of 25 to 85%;
an additive in a range of 10 to 38%; and
a humectant in a range of 10 to 25%.

2. The desiccant-based humidity regulator composition as claimed in claim 1, wherein the desiccant being silica gel having particle size between 200 to 400 mesh and water activity (Aw) in the range of 0.65 to 0.68.

3. The desiccant-based humidity regulator composition as claimed in claim 1, wherein the additive being a powdered alum.

4. The desiccant-based humidity regulator composition as claimed in claim 1, wherein the humectant being a solution of glycerin and water having water activity between 0.58 to 0.60.

5. The desiccant-based humidity regulator composition as claimed in claim 4, wherein the ratio of glycerin and water being 70:30.

6. The desiccant-based humidity regulator composition as claimed in claim 1, wherein the desiccant-based humidity regulator optionally includes an oxygen absorber composition.

7. The desiccant-based humidity regulator composition as claimed in claim 6, wherein the desiccant-based humidity regulator includes
a desiccant in a range of 20 to 60%;
an additive in a range of 5 to 25%;
a humectant in a range of 5 to 20%; and
an oxygen absorber composition in a range of 5 to 20%.

8. The desiccant-based humidity regulator composition as claimed in claim 6, wherein oxygen absorber composition includes
a sodium L-ascorbate in a range of 38 to 42%;
a sodium sulphite in a range of 18 to 25%; and
a molecular sieve 4A in a range of 19 to 22%.
